(19) United States
(12) Patent Application Publication
(10) Pub. No.: US 2025/0080913 A1
(43) Pub. Date: Mar. 6, 2025

(54) GLASS VIBRATION PLATE AND VIBRATOR-EQUIPPED GLASS VIBRATION PLATE

(71) Applicant: AGC Inc., Tokyo (JP)

(72) Inventors: Kento SAKURAI, Tokyo (JP); Daisuke UCHIDA, Tokyo (JP); Jun AKIYAMA, Tokyo (JP)

(73) Assignee: AGC Inc., Tokyo (JP)

(21) Appl. No.: 18/951,331

(22) Filed: Nov. 18, 2024

Related U.S. Application Data
(63) Continuation of application No. PCT/JP2023/018503, filed on May 17, 2023.

(30) Foreign Application Priority Data
May 19, 2022 (JP) 2022-082516

(51) Int. Cl. H04R 7/02; H04R 9/06

(52) U.S. Cl. CPC H04R 7/02; H04R 9/06; H04R 2499/13

(57) ABSTRACT

A glass diaphragm includes: a glass plate structure; a mounting member that is fixed to the glass plate structure and to which an exciter for vibrating the glass plate structure is to be attached; and an adhesive layer in contact with the glass plate structure and the mounting member, in which the adhesive layer includes a first adhesive layer and a second adhesive layer, a material of the first adhesive layer is different from a material of the second adhesive layer, the first adhesive layer has a shear storage modulus of 1.0×10⁷ [Pa] or less at −40 [° C.], and the second adhesive layer has a shear peel strength of 0.2 [MPa] or more at 80 [C].

### CROSS-REFERENCE TO RELATED APPLICATIONS

This is a bypass continuation of International Patent Application No. PCT/JP2023/018503, filed on May 17, 2023, which claims priority to Japanese Patent Application No. 2022-082516, filed on May 19, 2022. The contents of these applications are hereby incorporated by reference in their entireties.

### TECHNICAL FIELD

The present invention relates to a glass diaphragm and an exciter-attached glass diaphragm.

### BACKGROUND ART

In recent years, a technique has been studied in which various plate-shaped members, for example, an electronic device member, a vehicular window member, and an interior member of a transport machine such as a vehicle, are vibrated to function as a speaker. For example, Patent Literatures 1 to 5 disclose various structures that transmit vibration of an electrically vibrating exciter (vibrator) to a diaphragm such as a glass plate.

Patent Literature 1 discloses a structure in which a sole, a base, and an attachment are laminated in order on a main surface of a glass plate, the sole and the base are fixed with a plastic portion that covers a portion of the glass plate, and an exciter is connected to the attachment on the fixed base.

### CITATION LIST

### Patent Literature

Patent Literature 1: WO2021/229179
Patent Literature 2: WO2021/229180
Patent Literature 3: WO2019/172076
Patent Literature 4: JP2010-263512A
Patent Literature 5: JP2009-100223A

### SUMMARY OF INVENTION

However, with such an attachment structure for attaching the exciter to the glass plate, continued use of the vibrating exciter may cause an attachment position to displace, resulting in a decrease in sound reproduction quality or the exciter itself falling off. In addition, in a structure in which the sole and the base are fixed to the glass plate by the plastic portion, such as the attachment structure described in Patent Literature 1, there are problems such as a complicated configuration or difficulty in stably overcoating the plastic portion on the sole and the base. Further, there is a risk that a fixing strength between the sole and the base by the plastic portion decreases due to a temperature change.

Therefore, an object of the present invention is to provide a glass diaphragm and an exciter-attached glass diaphragm in which an exciter can be stably attached to a glass plate structure, a decrease in quality of sound emitted from the glass diaphragm and falling off of the exciter due to displacement of the exciter can be prevented, and a decrease in fixing strength due to a temperature change can be prevented.

The present invention has the following configurations.

(1) A glass diaphragm including:
a glass plate structure;
a mounting member that is fixed to the glass plate structure and to which an exciter for vibrating the glass plate structure is to be attached; and
an adhesive layer in contact with the glass plate structure and the mounting member, in which
the adhesive layer includes a first adhesive layer and a second adhesive layer made of different materials,
a material of the first adhesive layer is different from a material of the second adhesive layer,
the first adhesive layer has a shear storage modulus of 1.0×10⁷ [Pa] or less at −40 [° C.], and the second adhesive layer has a shear peel strength of 0.2 [MPa] or more at 80 [° C.].

(2) An exciter-attached glass diaphragm including: the glass diaphragm according to the above (1); and an exciter.

According to the present invention, the exciter can be stably attached to the glass plate structure, a decrease in quality of sound emitted from the glass diaphragm and falling off of the exciter due to displacement of the exciter can be prevented, and a decrease in fixing strength due to a temperature change can be prevented.

### BRIEF DESCRIPTION OF DRAWINGS

FIG. 1 is a schematic plan view of a glass diaphragm.

FIG. 2 is a schematic cross-sectional view of the glass diaphragm taken along a line II-II in FIG. 1.

FIG. 3 is a perspective view of a mounting member and an exciter fixed to a glass plate structure.

FIG. 4 is a schematic cross-sectional view taken along a line IV-IV in FIG. 2.

FIG. 5 is a schematic cross-sectional view of a glass diaphragm according to a first modification.

FIG. 6 is a schematic cross-sectional view of a glass diaphragm according to a second modification.

FIG. 7 is a schematic cross-sectional view of a glass diaphragm according to a third modification.

FIG. 8A is a schematic cross-sectional view taken along a surface direction of an adhesive layer, showing a disposition pattern of a first adhesive layer and a second adhesive layer.

FIG. 8B is a schematic cross-sectional view taken along the surface direction of the adhesive layer, showing a disposition pattern of the first adhesive layer and the second adhesive layer.

FIG. 8C is a schematic cross-sectional view taken along the surface direction of the adhesive layer, showing a disposition pattern of the first adhesive layer and the second adhesive layer.

FIG. 9 is a perspective view of a test piece illustrating a method for evaluating a shear stress.

FIG. 10 is a schematic diagram of an adhesive layer showing an adhesive layer in which two types of adhesives are combined.

FIG. 11 is a schematic configuration diagram of a test device illustrating a method for evaluating vibration transmissibility.

FIG. 12A is a schematic cross-sectional view of an adhesive layer showing another example of a disposition pattern of the first adhesive layer and the second adhesive layer.

FIG. 12B is a schematic plan view of the adhesive layer shown in FIG. 12A.

### DESCRIPTION OF EMBODIMENTS

Hereinafter, an embodiment of the present invention will be described in detail with reference to the drawings. An exciter-attached glass diaphragm according to the present embodiment includes a glass diaphragm and an exciter configured to vibrate the glass diaphragm, and can be applied to, for example, an application for vibrating a vehicular glass plate. In the following description, an example will be described in which the exciter-attached glass diaphragm is applied to a window portion such as a side window of a vehicle, but the application is not limited to this.

### <Overall Configuration of Glass Diaphragm>

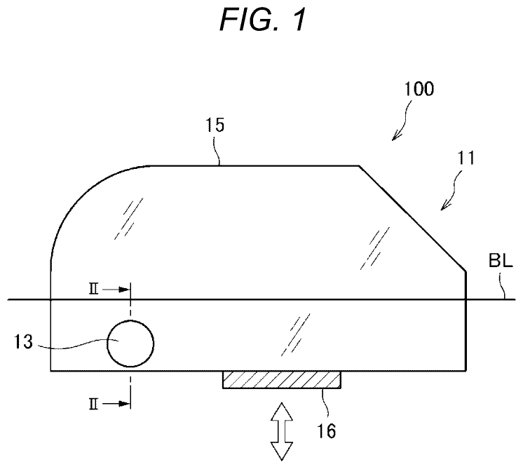

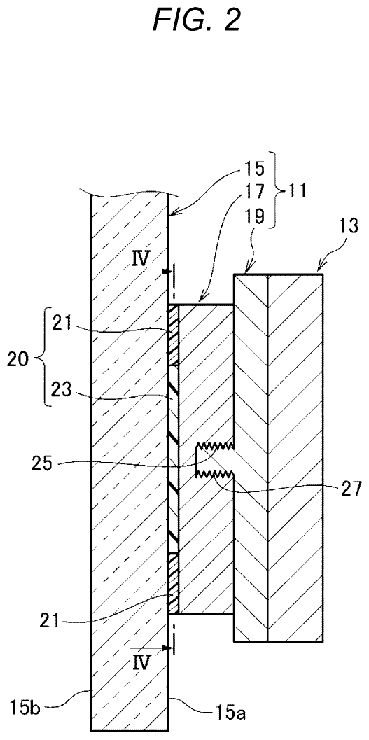

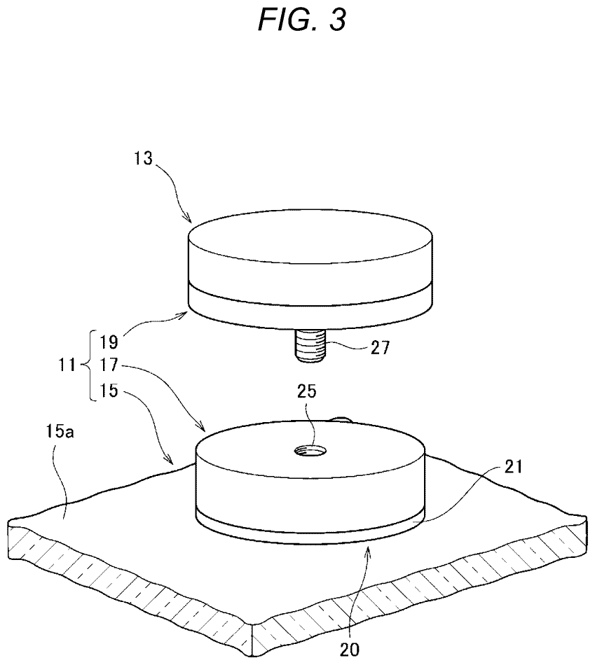

FIG. 1 is a schematic plan view of a glass diaphragm 11. FIG. 2 is a schematic cross-sectional view of the glass diaphragm 11 taken along a line II-II in FIG. 1. FIG. 3 is a perspective view of a mounting member 17 and an exciter 13 fixed to a glass plate structure 15.

As shown in FIG. 1 to FIG. 3, in the glass diaphragm 11, the exciter 13 for generating vibration is mountable to a main surface of the glass plate structure 15. Specifically, the glass diaphragm 11 includes the glass plate structure 15, the mounting member 17, and a connection member 19.

### <Configuration of Exciter-Attached Glass Diaphragm>

An exciter-attached glass diaphragm 100 has a configuration in which the exciter 13 is mounted to the glass diaphragm 11. The exciter 13 is connected and fixed to the connection member 19, and the connection member 19 is fixed to the mounting member 17. The exciter 13 is fixed to the connection member 19 by at least one of a mechanical fastening method such as a screw, a bolt and a nut, a rivet, a key, and a pin, and an adhesive. Note that, the exciter 13 and the connection member 19 may be configured to be firmly fixed to each other using different members, or may be configured to be integrated into one body using the same member. The connection member 19 is mechanically fixed to the mounting member 17. The mounting member 17 is fixed to a first main surface 15a, which is one of main surfaces of the glass plate structure 15. Accordingly, the exciter 13 is mounted to the first main surface 15a of the glass plate structure 15 via the connection member 19 and the mounting member 17.

For example, when the glass diaphragm 11 is used as a side window of a vehicle, the exciter 13 is disposed in a region below a belt line BL, that is, in a region on a frame 16 side of a lifting mechanism (not shown). Accordingly, sound generated from the glass plate structure 15 can be supplied to the inside of the vehicle. Note that, the belt line BL corresponds to a lower side of an opening when the side window is fully closed once the side window is attached to the vehicle (door).

The exciter 13 is a vibration device that uses an object that it comes into contact with as a diaphragm and generates sound from the diaphragm. The exciter-attached glass diaphragm 100 with the exciter 13 mounted thereto generates desired sound by vibrating the glass diaphragm 11 when the exciter 13 is driven. The exciter 13 used here may be an exciter (not shown) that includes a coil portion electrically connected to an external device, a magnetic circuit portion, and a vibration portion. With this exciter, when an electric signal of sound from the external device is input to the coil portion, the coil portion or the magnetic circuit portion vibrates due to interaction between the coil portion and the magnetic circuit portion. The vibration of the coil portion or the magnetic circuit portion is transmitted to the vibration portion, and the vibration portion generates vibration. Note that, the exciter 13 is provided with a conductive wire (not shown) for driving the exciter 13.

### <Glass Plate Structure>

The glass plate structure 15 constituting the glass diaphragm 11 includes the first main surface 15a and a second main surface 15b. Here, the glass plate structure 15 is exemplified as a single glass plate (single plate glass), but it may have another form, such as a laminated glass in which an intermediate layer such as a resin interlayer or a liquid is sandwiched between a pair of glass plates. A thickness of the glass plate structure 15 is preferably 1 [mm] or more, more preferably 2 [mm] or more, and still more preferably 3 [mm] 20 or more. Accordingly, the strength of the glass plate structure 15 can be made sufficient as required.

### <Mounting Member>

The mounting member 17 can be formed of a metal material such as aluminum or an aluminum alloy, a titanium alloy, a magnesium alloy, or stainless steel, or a material such as a ceramic, a glass, a resin material, a carbon fiber, or a composite material made of these. Examples of the resin material include acrylic resins such as a polymethyl methacrylate resin (PMMA), a polycarbonate (PC), polyvinyl chloride (PVC), urethane, a polypropylene (PP), an ABS resin, polybutylene terephthalate (PBT), polyphenylene sulfide (PPS), a polystyrene (PS), and nylon 66, which have excellent formability. Further, the above material is more preferably a fiber-reinforced plastic containing a glass fiber or a carbon fiber. By using the above materials, a sufficient connection strength can be obtained without causing cracks or the like in the mounting member 17. The mounting member 17 may be made of a single material, but may also be made of a composite material such as an aluminum alloy and stainless steel, or a resin material and stainless steel.

The mounting member 17 is formed in a circular shape in a plan view of the glass plate structure 15. An adhesive layer 20 in contact with the glass plate structure 15 and the mounting member 17 is provided between the glass plate structure 15 and the mounting member 17. The mounting member 17 is adhesively fixed to the first main surface 15a of the glass plate structure 15 by the adhesive layer 20. Note that, an outer edge shape of the mounting member 17 in the plan view of the glass plate structure 15 is not limited to a circular shape, and may be any shape such as a polygon.

The mounting member 17 includes a screw hole 25 on a side opposite to a side fixed to the glass plate structure 15. The connection member 19 provided on the exciter 13 includes a screw shaft 27, and the connection member 19 is fastened to the mounting member 17 by screwing this screw shaft 27 into the screw hole 25 of the mounting member 17 adhesively fixed to the glass plate structure 15 (see FIG. 2 and FIG. 3).

In this way, the connection member 19 fixed to the exciter 13 is mechanically fixed to the mounting member 17 adhesively fixed to the glass plate structure 15, and the exciter 13 is stably attached to the glass plate structure 15. In addition, when the connection member 19 screwed into the mounting member 17 is loosened, the exciter 13 (in this case, a member to which the exciter 13 and the connection member 19 are fixed) can be removed from the glass plate structure 15, so that the exciter 13 can be easily replaced. Note that, the screw structure between the connection member 19 and the mounting member 17 is not limited to a combination of the connection member 19 having a convex screw portion and the mounting member 17 having a concave screw portion screwed thereto, but may also be a combination of the connection member 19 having a concave screw portion and the mounting member 17 having a convex screw portion screwed thereto. Further, the fixing structure between the mounting member 17 and the connection member 19 is not limited to the screw structure, but may be, for example, a mechanical fastening method such as a rivet, a key, or a pin.

### <Adhesive Layer>

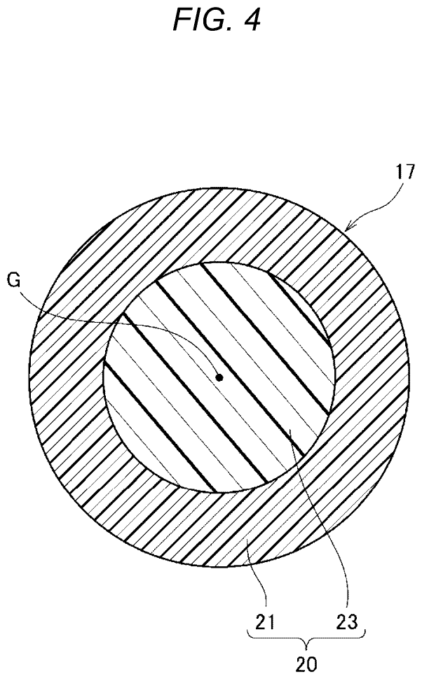

FIG. 4 is a schematic cross-sectional view taken along a line IV-IV in FIG. 2.

As shown in FIG. 4, the adhesive layer 20 between the glass plate structure 15 and the mounting member 17 includes a first adhesive layer 21 and a second adhesive layer 23. The first adhesive layer 21 and the second adhesive layer 23 are made of different materials. The first adhesive layer 21 is disposed in an annular shape along an outer edge of the mounting member 17, and the second adhesive layer 23 is disposed in a central portion of the mounting member 17. The first adhesive layer 21 and the second adhesive layer 23 are in contact with both the glass plate structure 15 and the mounting member 17. The mounting member 17 is adhesively fixed to the first main surface 15a of the glass plate structure 15 by the first adhesive layer 21 and the second adhesive layer 23. Accordingly, the mounting member 17 to which the exciter 13 or a member in which the connection member 19 and the exciter 13 are integrated is fixed can be easily fixed to the glass plate structure 15 with a simple structure.

As the adhesive layer 20 for adhesively fixing the mounting member 17 to the glass plate structure 15, it is preferable to use an adhesive capable of firmly fixing the mounting member 17 to the glass plate structure 15. However, when a liquid or gel adhesive that provides a high adhesive strength is used, the adhesive layer 20 becomes thick, and the vibration applied from the exciter 13 is absorbed by the adhesive layer 20, which may reduce the acoustic effect. Therefore, it is preferable to use, as the adhesive layer 20, a pressure-sensitive adhesive tape which can adhere at a smaller thickness than a liquid or gel adhesive and which has good handleability. Examples of the pressure-sensitive adhesive tape include acrylic, silicone, urethane, and epoxy silicone pressure-sensitive adhesive tapes.

Since the glass diaphragm 11, particularly when also used as an automobile glass window, is expected to be used in extremely hot or cold regions, the glass plate structure 15 and the mounting member 17 are required to be able to maintain a firmly fixed state without being influenced by a temperature change even in, for example, an assumed temperature range for use from a low temperature range (−40[° C.]) to a high temperature range (80[° C.]). Specifically, the exciter 13 and the mounting member 17 may be subjected to a sudden and instantaneous shear stress, and are thus required to be able to at least withstand a stress of 0.2 [MPa] or more per unit area in the assumed temperature range for use.

Here, examples of the adhesive such as a pressure-sensitive adhesive tape that provides a good acoustic effect due to a small thickness include a low temperature durable type that has excellent vibration durability in a low temperature range, and a high temperature durable type that has an excellent shear peel strength in a high temperature range.

However, the low temperature durable type adhesive softens in the high temperature range, and peeling may occur due to a decrease in shear peel strength. In addition, the high temperature durable type adhesive is brittle in the low temperature range, the vibration durability may decrease, and cracks may be generated. Note that, although there is an intermediate temperature durable type adhesive, a sufficient adhesive strength may not be obtained in the high temperature range and the low temperature range within the assumed temperature range for use (−40 [C] to 80[° C.]) of the glass diaphragm 11.

Therefore, when the glass plate structure 15 adheres to the mounting member 17 using any one of the low temperature durable type adhesive, the high temperature durable type adhesive, and the intermediate temperature durable type adhesive, it is difficult to maintain a firmly fixed state due to a temperature change in the assumed temperature range for use (−40 [C] to 80[° C.]).

Therefore, the inventors of the present invention have found that when the adhesive layer 20 for adhesively fixing the glass plate structure 15 and the mounting member 17 includes a combination of the first adhesive layer 21 made of a low temperature durable type adhesive and the second adhesive layer 23 made of a high temperature durable type adhesive, a decrease in fixing strength due to a temperature change in the assumed temperature range for use (−40[° C.] to 80[° C.]) is prevented while obtaining a good acoustic effect.

In this configuration example, the adhesive layer 20 is configured to include the first adhesive layer 21 and the second adhesive layer 23 made of different materials, and for example, the first adhesive layer 21 is made of a low temperature durable type adhesive and the second adhesive layer 23 is made of a high temperature durable type adhesive.

Specifically, the adhesive layer 20 for adhesively fixing the glass plate structure 15 and the mounting member 17 is configured by combining the first adhesive layer 21 having a shear storage modulus of 1.0×10⁷ [Pa] or less at −40 [° C.] and the second adhesive layer 23 having a shear peel strength of 0.2 [MPa] or more at 80 [° C.]. Accordingly, regardless of the temperature change, the glass plate structure 15 and the mounting member 17 can be maintained in a firmly fixed state, and the attachment state of the exciter 13 or the member in which the connection member 19 and the exciter 13 are integrated to the glass plate structure 15 can be stably maintained even in extremely hot or cold regions. In addition, the shear storage modulus of the first adhesive layer 21 at −40 [° C.] is preferably 1.0×10⁷ [Pa] or less, more preferably 7.0×10⁶ [Pa] or less, and still more preferably 5.0×10⁶ [Pa] or less. Further, the shear peel strength of the second adhesive layer 23 at 80 [° C.] is preferably 0.2 [MPa] or more, more preferably 0.4 [MPa] or more, and still more preferably 0.5 [MPa] or more.

In particular, the adhesive layer 20 including the first adhesive layer 21 and the second adhesive layer 23 preferably has an average shear peel strength of 0.2 [MPa] or more in the range of −40 [° C.] to 80 [° C.]. Accordingly, the fixing structure of the mounting member 17 to the glass plate structure 15 can be made more resistant to the temperature change. In addition, the average shear peel strength of the adhesive layer 20 in the range of −40 [° C.] to 80 [° C.] is more preferably 0.4 [MPa] or more, and still more preferably 0.6 [MPa] or more.

Further, in this configuration example, the first adhesive layer 21 and the second adhesive layer 23 constituting the adhesive layer 20 have a thickness of 1 [μm] to 1.0 [mm].

Here, for example, the adhesive layer 20 made of a pressure-sensitive adhesive tape or the like tends to be subjected to greater physical forces as the thickness of the layer increases, resulting in a decrease in strength. Therefore, in order to increase the strength of the adhesive layer 20, it is desirable to make the adhesive layer 20 thinner. However, the adhesive has a range of thickness within which it is most stretchable or most likely to exhibit strength, depending on a relationship between a polymer composition or a crosslink density and physical entanglement with a compound. Further, the adhesive layer 20 is required to be able to efficiently transmit the vibration of the exciter 13 to the glass plate structure 15 via the mounting member 17.

As in this configuration example, when the first adhesive layer 21 and the second adhesive layer 23 constituting the adhesive layer 20 have a thickness of 1 [μm] to 1.0 [mm], the vibration of the exciter 13 can be efficiently transmitted to the glass plate structure 15 via the mounting member 17 while the adhesive strength of the mounting member 17 to the glass plate structure 15 is sufficiently ensured, and an excellent acoustic effect can be obtained. Note that, the thickness of the adhesive layer 20 is preferably equal to or larger than a surface roughness of the glass, more preferably 5 [μm] or more, and still more preferably 10 [μm] or more. In addition, the thickness of the adhesive layer 20 is more preferably 0.5 [mm] or less, and still more preferably 0.2 [mm] or less.

Note that, in the glass diaphragm 11 according to this configuration example, at least one of the first adhesive layer 21 and the second adhesive layer 23 preferably has a loss coefficient tan δ of 0.01 or more at −40 [° C.]. The loss coefficient tan δ is a ratio of the shear storage modulus to a shear loss modulus, and the larger the loss coefficient tan δ, the more impact can be absorbed. Therefore, when at least one of the first adhesive layer 21 and the second adhesive layer 23 has a loss coefficient tan δ of 0.01 or more at −40 [C], in particular, impact resistance in cold regions is improved, and the firmly fixed state of the mounting member 17 to the glass plate structure 15 can be maintained more satisfactorily. In addition, the loss coefficient tan δ at −40 [° C.] of at least one of the first adhesive layer 21 and the second adhesive layer 23 is more preferably 0.5 or more, and still more preferably 0.1 or more. Further, the loss coefficient tan δ at −40 [° C.] of both the first adhesive layer 21 and the second adhesive layer 23 is preferably 0.01 or more, more preferably 0.02 or more, and still more preferably 0.05 or more.

In this configuration example, the thickness of the first adhesive layer 21 is approximately the same as that of the second adhesive layer 23. Accordingly, the mounting member 17 can be adhesively fixed to the glass plate structure 15 by the first adhesive layer 21 and the second adhesive layer 23 in a well-balanced manner.

Note that, when a surface area of the first adhesive layer 21 in contact with the glass plate structure 15 is S1, and a surface area of the second adhesive layer 23 in contact with the glass plate structure 15 is S2, a ratio S1:S2 preferably satisfies a range of 1:0.01 to 1:100. Accordingly, the surface areas of the first adhesive layer 21 and the second adhesive layer 23 in contact with the glass plate structure 15 can be set to have an appropriate ratio, and the mounting member 17 can satisfactorily adhere to the glass plate structure 15 by the first adhesive layer 21 and the second adhesive layer 23. Note that, since it is intended for use in a wide range of temperature environments, it is more preferable that S1 and S2 have a similar area. For the above reasons, a ratio satisfying a range of 1:0.1 to 1:10 is more preferred, a ratio satisfying the range of 1:0.2 to 1:5 is still more preferred, and a ratio satisfying a range of 1:0.5 to 1:2 is particularly preferred.

In addition, a total area of the surface area S1 of the first adhesive layer 21 in contact with the glass plate structure 15 and the surface area S2 of the second adhesive layer 23 in contact with the glass plate structure 15 is preferably 100 [mm²] or more. Accordingly, the surface areas of the first adhesive layer 21 and the second adhesive layer 23 in contact with the glass plate structure 15 can be sufficiently ensured, and the mounting member 17 can be satisfactorily adhesively fixed to the glass plate structure 15 by the first adhesive layer 21 and the second adhesive layer 23. Note that, the total area of the surface area S1 of the first adhesive layer 21 and the surface area S2 of the second adhesive layer 23 in contact with the glass plate structure 15 is more preferably 200 [mm²] or more, and still more preferably 400 [mm²] or more. On the other hand, the total area of the surface area S1 of the first adhesive layer 21 and the surface area S2 of the second adhesive layer 23 in contact with the glass plate structure 15 is preferably 10,000 [mm²] or less, more preferably 5,000 [mm²] or less, and still more preferably 2,000 [mm²] or less, in terms that the area occupied by the mounting member 17 is too large and the weight of the mounting member 17 increases.

In addition, in the plan view of the glass plate structure 15, the first adhesive layer 21 is disposed in an annular shape along the outer edge of the mounting member 17, and the second adhesive layer 23 is disposed in the central portion of the mounting member 17. Accordingly, in the plan view of the glass plate structure 15, a center of gravity G of the mounting member 17 overlaps the second adhesive layer 23 (see FIG. 4). In addition, the second adhesive layer 23 overlapping the center of gravity G of the mounting member 17 is disposed in a circular shape centered on the center of gravity G of the mounting member 17 in the plan view of the glass plate structure 15. Therefore, the second adhesive layer 23 is disposed in a region (first region) point-symmetric with respect to the center of gravity G of the mounting member 17. Further, in the plan view of the glass plate structure 15, the first adhesive layer 21 is disposed in an annular shape along the outer edge of the mounting member 17 so as to surround a periphery of the second adhesive layer 23. In this case, the first adhesive layer 21 may also be disposed in a region (second region) point-symmetric with respect to the center of gravity G of the mounting member 17, and is disposed in a point-symmetric region in the present embodiment. Here, both the first region and the second region are point-symmetric with respect to the center of gravity G of the mounting member 17. However, it is sufficient that at least one of the regions is point-symmetric with respect to the center of gravity G, and it is preferable that both regions be point-symmetric with respect to the center of gravity G.

In this way, when the first adhesive layer 21 and the second adhesive layer 23 are disposed, adhesive forces of the first adhesive layer 21 and the second adhesive layer 23 are imparted between the glass plate structure 15 and the mounting member 17 in a well-balanced manner. Accordingly, the mounting member 17 can be adhesively fixed to the glass plate structure 15 in a more balanced manner. Note that, as described above, the state where each region in the first adhesive layer 21 and the second adhesive layer 23 is formed to be point-symmetric with respect to the center of gravity G of the mounting member 17 is not limited to perfect point symmetry, and as long as the shape can be visually recognized as point-symmetric, some deviation is permissible.

Note that, in the above configuration example, a case where the mounting member 17 having a circular shape in a plan view is used is illustrated, but the mounting member 17 may have a polygonal shape in a plan view, such as a triangle or a rectangle, or may have any shape including a curved line in addition to the polygonal shape. In this way, when the mounting member 17 has any shape in the plan view of the glass plate structure 15, the adhesive layer 20 may have an outer edge having a shape same as the outer edge of the mounting member 17, or may have a portion where the outer edge is positioned more inward than the outer edge of the mounting member 17. In this case, it is also preferable that each region in the first adhesive layer 21 and the second adhesive layer 23 included in the adhesive layer 20 be formed to be point-symmetric with respect to the center of gravity G of the mounting member 17.

In addition, the positions of the first adhesive layer 21 and the second adhesive layer 23 disposed between the glass plate structure 15 and the mounting member 17 may be reversed. In this case, the adhesive forces of the first adhesive layer 21 and the second adhesive layer 23 can also be imparted between the glass plate structure 15 and the mounting member 17 in a well-balanced manner.

Further, the adhesive layer 20 may include not only the first adhesive layer 21 and the second adhesive layer 23 but also a third adhesive layer (not shown). In this case, the third adhesive layer may be an adhesive layer having physical properties different from those of the first adhesive layer 21 and the second adhesive layer 23, or may be an adhesive layer same as the first adhesive layer 21 or the second adhesive layer 23. When the third adhesive layer is different from the first adhesive layer 21 and the second adhesive layer 23, the fixing strength can be easily adjusted according to the temperature change in the range of −40 [° C.] to 80 [C]. When the third adhesive layer is an adhesive layer made of a material same as that of the first adhesive layer 21 or the second adhesive layer 23, the third adhesive layer is disposed at a distance from the adhesive layer made of the same material. Further, even when the adhesive layer 20 includes the third adhesive layer (not shown), it is preferable that each region in the first adhesive layer 21, the second adhesive layer 23, and the third adhesive layer be formed to be point-symmetric with respect to the center of gravity G of the mounting member 17.

The fixing structure between the glass plate structure 15 and the mounting member 17 in the glass diaphragm 11 according to this configuration example described above is merely an example, and can be modified to various configurations.

Hereinafter, modifications of the fixing structure between the glass plate structure 15 and the mounting member 17 will be described. Note that, in the following description, the same or corresponding reference numeral is imparted to the same or corresponding portions or members, and duplicated description is thereby omitted.

### (First Modification)

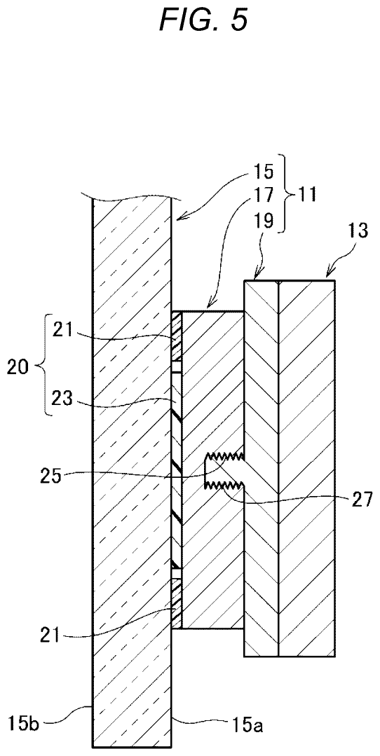

FIG. 5 is a schematic cross-sectional view of the glass diaphragm 11 according to a first modification.

As shown in FIG. 5, in the glass diaphragm 11 according to the first modification, a gap is provided along a circumferential direction between the second adhesive layer 23 disposed in the central portion of the mounting member 17 and the first adhesive layer 21 disposed in an annular shape along the outer edge of the mounting member 17. Accordingly, the first adhesive layer 21 and the second adhesive layer 23 have portions spaced apart from each other. In the glass diaphragm 11 according to the first modification, since the first adhesive layer 21 and the second adhesive layer 23 have portions spaced apart from each other, even when the volume of at least one of the first adhesive layer 21 and the second adhesive layer 23 increases due to thermal expansion caused by a temperature change, it is easier to prevent the generation of the stress caused by the first adhesive layer 21 and the second adhesive layer 23 coming into contact with each other and interfering with each other.

### (Second Modification)

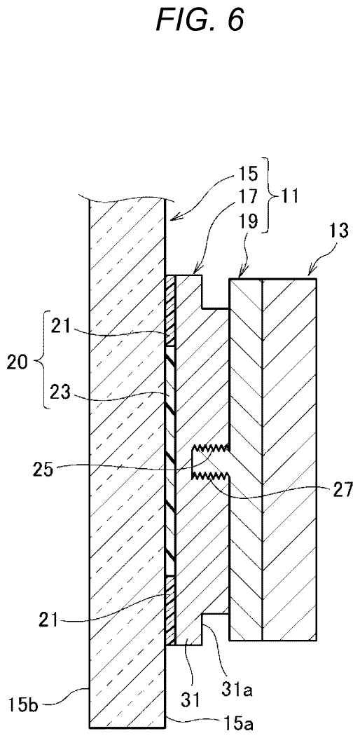

FIG. 6 is a schematic cross-sectional view of the glass diaphragm 11 according to a second modification.

As shown in FIG. 6, in the glass diaphragm 11 according to the second modification, the mounting member 17 includes an enlarged diameter portion 31 on the side fixed to the glass plate structure 15. Accordingly, the mounting member 17 includes a step 31a toward the glass plate structure 15. In the mounting member 17 having such a shape, an area on the glass plate structure 15 side can be made larger than an area on a side away from the glass plate structure 15 in the plan view of the glass plate structure 15.

In the glass diaphragm 11 according to the second modification, an area of the mounting member 17 on the side fixed to the glass plate structure 15 can be increased, and the adhesive strength of the mounting member 17 to the glass plate structure 15 by the first adhesive layer 21 and the second adhesive layer 23 can be increased.

Note that, in the glass diaphragm 11 according to the second modification, there is the step 31a formed by enlarging the diameter of the mounting member 17 on the side fixed to the glass plate structure 15. However, the mounting member 17 may have a truncated cone shape that is gradually enlarged in diameter toward the glass plate structure 15, and in this case, the area of the mounting member 17 on the side fixed to the glass plate structure 15 can also be increased.

### (Third Modification)

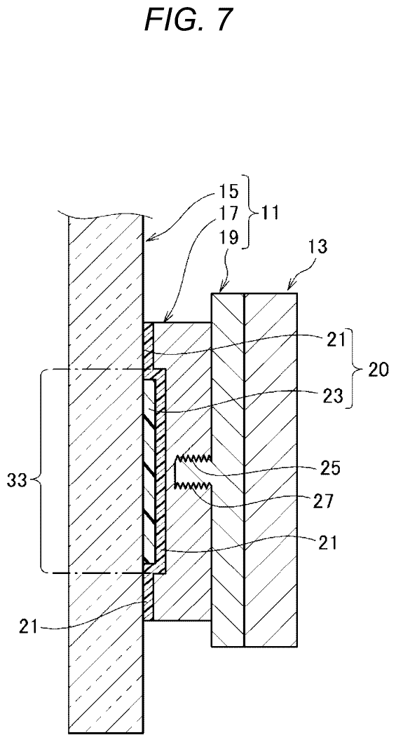

FIG. 7 is a schematic cross-sectional view of the glass diaphragm 11 according to a third modification.

As shown in FIG. 7, in the glass diaphragm 11 according to a third modification, the mounting member 17 includes a recessed portion 33 in the central portion. The first adhesive layer 21 is disposed in an annular shape along the outer edge of the mounting member 17, and is further disposed on an inner circumferential surface and a bottom surface of the recessed portion 33 of the mounting member 17. In addition, the second adhesive layer 23 is disposed in the recessed portion 33 of the mounting member 17 whose inner circumferential surface and bottom surface are disposed with the first adhesive layer 21. Accordingly, in the recessed portion 33 of the mounting member 17, the first adhesive layer 21 and the second adhesive layer 23 overlap each other in a thickness direction. In the third modification, an outer edge portion of the mounting member 17 can adhere to the glass plate structure 15 by the first adhesive layer 21, and further, the central portion of the mounting member 17 can adhere to the glass plate structure 15 by the first adhesive layer 21 and the second adhesive layer 23 which overlap each other.

Next, various disposition patterns of the first adhesive layer 21 and the second adhesive layer 23 disposed between the glass plate structure 15 and the mounting member 17 will be described.

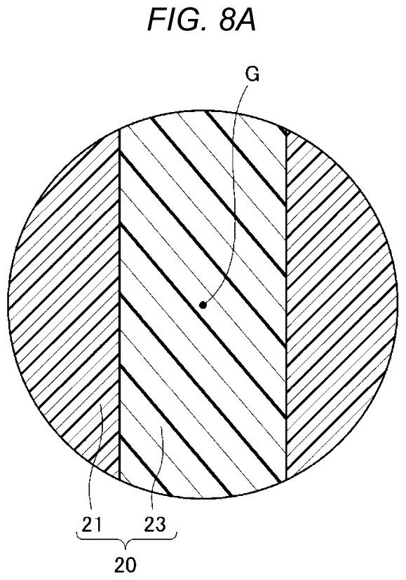

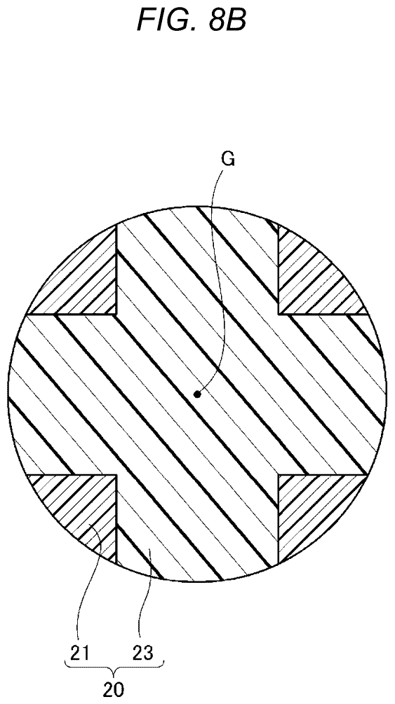

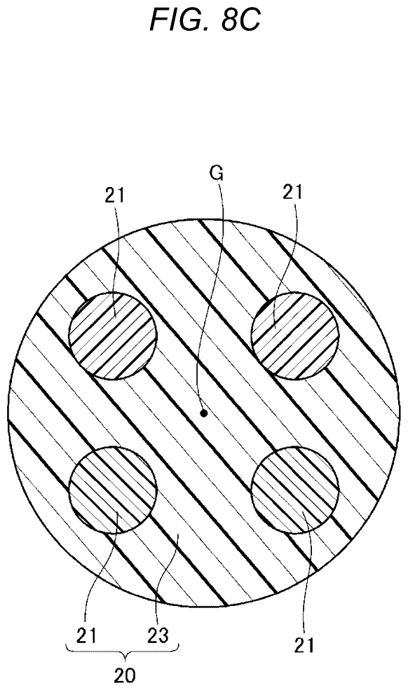

FIG. 8A to FIG. 8C are schematic cross-sectional views taken along a surface direction of the adhesive layer, each showing a disposition pattern of the first adhesive layer and the second adhesive layer.

In the disposition pattern shown in FIG. 8A, with respect to the mounting member 17, the second adhesive layer 23 is disposed in a straight line along a radial direction passing through the center of gravity G of the mounting member 17 in a plan view, and the first adhesive layer 21 is disposed in a portion other than where the second adhesive layer 23 is disposed.

In the disposition pattern shown in FIG. 8B, with respect to the mounting member 17, the second adhesive layer 23 is disposed in a cross shape centered on the center of gravity G of the mounting member 17 in a plan view, and the first adhesive layer 21 is disposed in a portion other than where the second adhesive layer 23 is disposed.

In the disposition pattern shown in FIG. 8C, with respect to the mounting member 17, a plurality of (four in this example) first adhesive layers 21 each having a circular shape are disposed at an equal interval around the center of gravity G of the mounting member 17, and the second adhesive layer 23 is disposed in a portion other than where these first adhesive layers 21 are disposed.

In all cases of the disposition patterns shown in FIG. 8A to FIG. 8C, the center of gravity G of the mounting member 17 is disposed at a position overlapping the second adhesive layer 23 in the plan view of the glass plate structure 15. In addition, the second adhesive layer 23 is disposed in a region (first region) point-symmetric with respect to the center of gravity G of the mounting member 17. Further, the first adhesive layer 21 is disposed in a region (second region) point-symmetric with respect to the center of gravity G of the mounting member 17 in the plan view of the glass plate structure 15.

As the disposition patterns shown in FIG. 8A to FIG. 8C, when the first adhesive layer 21 and the second adhesive layer 23 are disposed, the adhesive forces of the first adhesive layer 21 and the second adhesive layer 23 are imparted between the glass plate structure 15 and the mounting member 17 in a well-balanced manner. Accordingly, the mounting member 17 can be adhesively fixed to the glass plate structure 15 in a more balanced manner.

Note that, in the disposition patterns shown in FIG. 8A to FIG. 8C, the positions of the first adhesive layer 21 and the second adhesive layer 23 disposed may also be reversed. In this case, the adhesive forces of the first adhesive layer 21 and the second adhesive layer 23 can also be imparted between the glass plate structure 15 and the mounting member 17 in a well-balanced manner.

### Examples

### <Evaluation of Adhesive Layer>

The shear storage modulus and the loss coefficient were measured for various adhesive layers made of pressure-sensitive adhesive tapes, and the shear stress and the vibration transmissibility were evaluated. Note that, in the following evaluation, Test Examples 1 to 6, 8, and 9 are Comparative Examples, and Test Examples 7 and 10 are Inventive Examples.

### (Shear Storage Modulus and Loss Coefficient)

The shear storage modulus was measured for an adhesive A made of a high temperature durable type pressure-sensitive adhesive tape, an adhesive B made of an intermediate temperature durable type pressure-sensitive adhesive tape, and an adhesive C made of a low temperature durable type pressure-sensitive adhesive tape. Note that, the shear storage modulus and the loss coefficient were measured using a dynamic viscoelasticity measuring device (DVA-225, manufactured by IT Measurement & Control Co., Ltd.) at −40 [° C.], 25 [° C.], and 80 [° C.] in shear mode at 1 Hz. The loss coefficient of each type of adhesives A to C was measured at −40 [° C.]. The results of measuring the shear storage modulus of each type of adhesives A to C are shown in Table 1.

TABLE 1

| | | | |
|---|---|---|---|
| Temperature | Adhesive A | Adhesive B | Adhesive C |

| | | | | |
|---|---|---|---|---|
| 80° | C. | 3.0 × 10⁴ Pa | 1.0 × 10⁴ Pa | 7.7 × 10³ Pa |
| 25° | C. | 5.5 × 10⁴ Pa | 1.2 × 10⁴ Pa | 3.2 × 10⁴ Pa |
| −40° | C. | 1.3 × 10⁷ Pa | 1.1 × 10⁷ Pa | 5.0 × 10⁶ Pa |

As shown in Table 1, the shear storage modulus at −40 [° C.] is 1.3×10⁷ [Pa] for the adhesive A and 1.1×10⁷ [Pa] for the adhesive B. That is, it was assumed that both the adhesive A and the adhesive B had a shear storage modulus larger than 1.0×10⁷ [Pa] in the low temperature range (−40 [° C.]) and were brittle. In contrast, it could be seen that the adhesive C had a shear storage modulus of 5.0×10⁶ [Pa] at −40 [° C.], which is 1.0×10⁷ [Pa] or less, and had sufficient flexibility even in the low temperature range (−40 [C]).

In addition, the loss coefficient tan δ measured at −40 [° C.] was 0.06 for the adhesive A, 0.17 for the adhesive B, and 0.26 for the adhesive C. That is, all of the adhesives A to C had a loss coefficient tan δ of 0.01 or more at −40 [° C.], indicating that sufficient impact resistance was obtained even in cold regions.

### (Evaluation of Shear Stress)

### (1) Evaluation Method

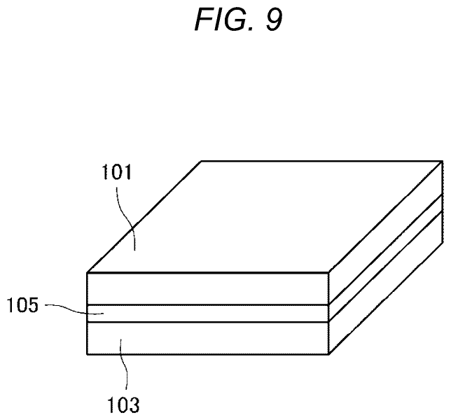

FIG. 9 is a perspective view of a test piece illustrating a method for evaluating a shear stress.

As shown in FIG. 9, an adhesive layer 105 in Test Examples 1 to 7 to be evaluated was sandwiched between a glass plate 101 having a width of 20 [mm], a length of 30 [mm], and a thickness of 3 [mm] and an aluminum plate (A6061) 103, and a load of 2 kg was applied in a thickness direction, followed by still-standing for 24 hours to adhere the glass plate 101 to the aluminum plate 103.

In order to simulate an instantaneous stress between the glass plate 101 and the aluminum plate 103 by adhesion of the adhesive layer 105, a shear force was applied at a speed of 300 [mm/min], and a stress at which the adhesive layer 105 underwent cohesive failure and the glass plate 101 and the aluminum plate 103 were peeled off was measured as the shear stress. This shear stress measurement was performed 10 times each at −40 [C], 25 [° C.], and 80 [° C.], and the average value was taken as the shear peel strength for each of Test Examples 1 to 7. Note that, a case where the adhesive layer 105 was peeled off at an interface and the glass plate 101 and the aluminum plate 103 were peeled off due to the application of the shear force was evaluated as unacceptable. The shear stress was measured using an autograph (AGX-V, manufactured by Shimadzu Corporation).

### (2) Test Examples 1 to 7 Used as Adhesive Layer 105

Test Example 1: an adhesive A having a thickness of 0.05 [mm]
Test Example 2: an adhesive A having a thickness of 0.25 [mm]
Test Example 3: an adhesive B having a thickness of 0.05 [mm]
Test Example 4: an adhesive B having a thickness of 0.30 [mm]
Test Example 5: an adhesive C having a thickness of 0.05 [mm]
Test Example 6: an adhesive C having a thickness of 0.40 [mm]
Test Example 7: a combination of an adhesive A having a thickness of 0.05 [mm] and an adhesive C having a thickness of 0.05 [mm]

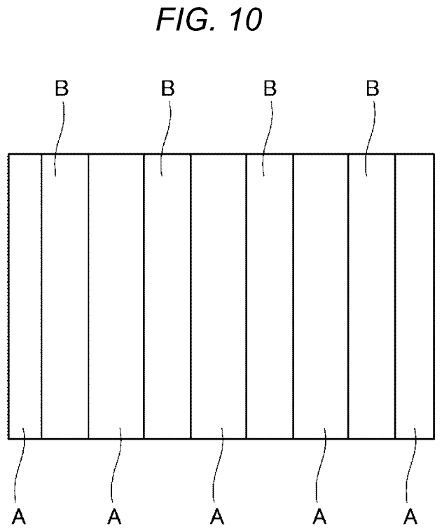

FIG. 10 is a schematic diagram of the adhesive layer 105 showing an adhesive layer 105 in which two types of adhesives A and B are combined.

As shown in FIG. 10, in Test Example 7 in which the adhesive A and the adhesive C were combined, the adhesive layer 105 was formed by alternately arranging strips of the adhesive A and the adhesive C. Note that, the area ratio (S1:S2) of the adhesive A to the adhesive C was set to 1:1.

### (3) Evaluation Results

The evaluation results are shown in Table 2.

TABLE 2

| | | Test | | Test | | Test | | Test | | Test | | Test | | Test | |
|---|---|---|---|---|---|---|---|---|---|---|---|---|---|---|---|
| | | Example 1 | | Example 2 | | Example 3 | | Example 4 | | Example 5 | | Example 6 | | Example 7 | |
| Thickness | | 0.05 | mm | 0.25 | mm | 0.05 | mm | 0.30 | mm | 0.05 | mm | 0.40 | mm | 0.05 | mm |
| 80° | C. | 0.70 | MPa | 0.46 | MPa | 0.16 | MPa | 0.10 | MPa | 0.12 | MPa | 0.06 | MPa | 0.73 | MPa |
| 25° | C. | 0.95 | MPa | 0.88 | MPa | 0.90 | MPa | 0.76 | MPa | 0.40 | MPa | 0.25 | MPa | 0.99 | MPa |

| | | | | | | | | | | | |
|---|---|---|---|---|---|---|---|---|---|---|---|
| −40° | C. | Interfacial | Interfacial | Interfacial | Interfacial | 1.20 | MPa | 0.45 | MPa | 1.21 | MPa |
| | | peeling | peeling | peeling | peeling | | | | | | |

| Average | — | — | — | — | 0.57 | MPa | 0.25 | MPa | 0.98 | MPa |
|---|---|---|---|---|---|---|---|---|---|---|
| value | | | | | | | | | | |

As shown in Table 2, in Test Examples 1 and 2 using the adhesive A, which was made of a high temperature durable type pressure-sensitive adhesive tape, the shear peel strength at 80 [C] was 0.70 [MPa] and 0.46 [MPa], respectively, and sufficient durability was obtained. However, in both Test Examples 1 and 2, interfacial peeling occurred at −40 [° C.], which was unacceptable.

In Test Examples 3 and 4 using the adhesive B, which was made of an intermediate temperature durable type pressure-sensitive adhesive tape, the shear peel strength at 80 [C] was 0.16 [MPa] and 0.10 [MPa], respectively, and sufficient durability was not obtained. In addition, in both Test Examples 3 and 4, interfacial peeling occurred at −40 [° C.], which was unacceptable.

In Test Examples 5 and 6 using the adhesive C, which was made of a low temperature durable type pressure-sensitive adhesive tape, the shear peel strength at 80 [C] was 0.12 [MPa] and 0.06 [MPa], respectively, and the durability was not sufficient. However, in Test Examples 5 and 6, the shear peel strength at −40 [° C.] was 1.2 [MPa] and 0.45 [MPa], respectively, and sufficient durability was obtained.

In contrast, in Test Example 7 in which the adhesive A and the adhesive C were combined, the shear peel strength was 0.73 [MPa] at 80 [° C.] and 1.21 [MPa] at −40 [C]. In this way, in Test Example 7, a sufficient shear peel strength was obtained over the entire temperature range. In addition, in Test Example 7, the flexibility in the low temperature range is also sufficiently compensated for by the adhesive C, which had a shear storage modulus of 1.0×10⁷ [Pa] or less at −40 [C] (see Table 1).

In addition, in Test Examples 5 to 7 in which no interfacial peeling occurred, the average value of the shear peel strengths (three values) at 80 [C], 25 [° C.], and −40 [C] was 0.57 [MPa] for Test Example 5, 0.25 [MPa] for Test Example 6, and 0.98 [MPa] for Test Example 7. In this way, in Test Examples 5 to 7 in which no interfacial peeling occurred, Test

Example 7 in which the adhesive A and the adhesive C were combined had an average shear peel strength in the range of −40 [C] to 80 [° C.] higher than that in Test Examples 5 and 6 using the adhesive C, which was made of a low temperature durable type pressure-sensitive adhesive tape.

Note that, the average shear peel strength in the range of −40 [° C.] to 80 [C] here was defined as the average value of the shear peel strengths at three points, 80 [° C.], 25 [C], and −40 [° C.] as described above, and was not remarkably different from the average value at more than three temperatures.

It could be seen from the result of the above evaluation of shear stress that when the glass plate structure 15 and the mounting member 17 were adhesively fixed to each other by the adhesive layer 20, which was a combination of the first adhesive layer 21 made of the adhesive C having a shear storage modulus of 1.0×10⁷ [Pa] or less at −40 [° C.] and the second adhesive layer 23 made of the adhesive A having a shear peel strength of 0.2 [MPa] or more at 80 [° C.], a large fixing strength between the glass plate structure 15 and the mounting member 17 could be maintained regardless of the temperature change in the assumed temperature range for use (−40 [C] to 80[° C.]). Accordingly, even in extremely hot or cold regions, the exciter 13 or the member in which the connection member 19 and the exciter 13 are integrated can be stably attached to the glass plate structure 15, and a decrease in quality of the sound emitted from the glass diaphragm 11 and falling off of the exciter 13 due to displacement of the exciter 13 can be prevented.

### (Evaluation of Vibration Transmissibility)

### (1) Evaluation Method

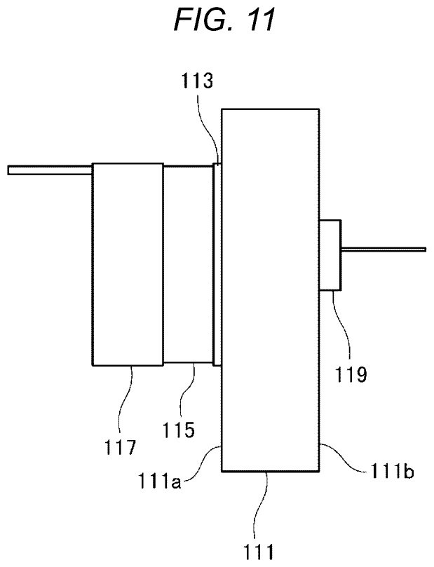

FIG. 11 is a schematic configuration diagram of a test device illustrating a method for evaluating vibration transmissibility.

As shown in FIG. 11, a mounting member 115 adhered to one main surface 111a of a glass plate structure 111 made of a laminated glass by an adhesive layer 113, and an exciter 117 was attached to the mounting member 115. A signal was input to the exciter 117 to vibrate at 50 Hz, and the vibration was measured by an acceleration sensor 119 mounted to a main surface 111b of the glass plate structure 111 on a side opposite to the side where the mounting member 115 was attached. Then, a vibration transmission delay was determined as a difference between the measurement signal and the output signal.

The glass plate structure 111 used was a laminated glass including two glass plates each having 200 [mm] in width, 300 [mm] in length, and 1.8 [mm] in thickness, sandwiching an intermediate layer made of polyvinyl butyral (PVB) and having 0.76 [mm] in thickness.

### (2) Test Examples 8 to 10 Used as Adhesive Layer 113

Test Example 8: an adhesive A having a thickness of 0.05 [mm]
Test Example 9: an adhesive A having a thickness of 0.50 [mm]
Test Example 10: a combination of an adhesive A having a thickness of 0.05 [mm] and an adhesive C having a thickness of 0.05 [mm]

Note that, in Test Example 10 in which the adhesive A and the adhesive C were combined, the adhesive layer 113 was also formed by alternately arranging strips of the adhesive A and the adhesive C, and the area ratio of the adhesive A to the adhesive C was set to 1:1

### (3) Evaluation Results

The evaluation results are shown in Table 3.

TABLE 3

| | | Vibration |
|---|---|---|
| | Thickness | transmission delay |
| Test Example 8 | 0.05 mm | 17.09 ms |
| Test Example 9 | 0.50 mm | 21.01 ms |
| Test Example 10 | 0.05 mm | 17.11 ms |

As shown in Table 3, in Test Example 8 using the adhesive A having a thickness of 0.05 [mm], the vibration transmission delay was reduced to 17.09 [ms]. In contrast, in Test Example 9 using the adhesive A having a thickness of 0.50 mm, the vibration transmission delay was 21.01 [ms]. That is, it can be seen that when the thickness increases, the influence of dynamic viscoelasticity of the adhesive A increases, and the vibration is absorbed.

In addition, in Test Example 10 in which the adhesive A and the adhesive C were combined, each having a thickness of 0.05 [mm], the vibration transmission delay was also reduced to 17.11 [mm]. That is, it can be seen that the vibration transmission delay is greatly influenced by the thickness of the adhesive, so that even in the case of Test Example 10 in which the adhesive A and the adhesive C were combined, when the thickness is small, the vibration transmission delay can be sufficiently reduced.

As described above, the present invention is not limited to the embodiment described above, and combinations of the configurations in the embodiment with each other, modifications and applications by those skilled in the art based on the description of the specification and known techniques are also contemplated by the present invention and are included in the scope of protection.

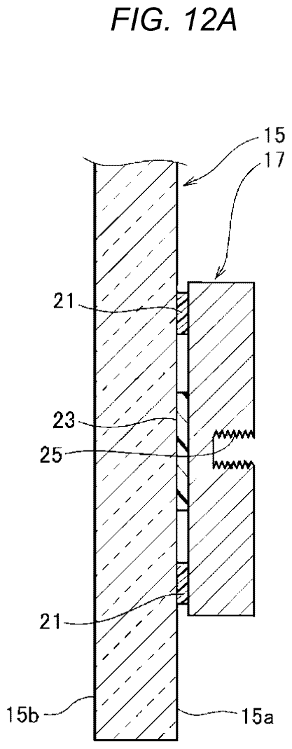

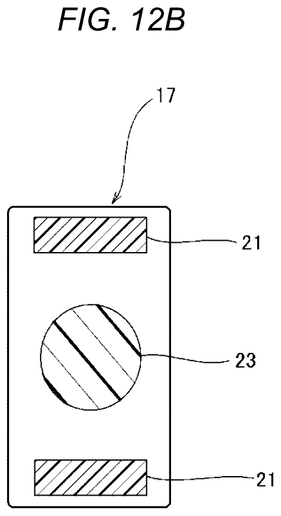

For example, in the first modification shown in FIG. 5, the glass diaphragm 11 in which the first adhesive layer 21 and the second adhesive layer 23 have portions spaced apart from each other was described, but also in this case, the disposition pattern of the first adhesive layer 21 and the second adhesive layer 23 is not limited. Another example of the disposition pattern may be a disposition pattern as shown in FIG. 12A and FIG. 12B, which are schematic cross-sectional view and schematic plan view of the adhesive layer, respectively. The planar shapes, sizes, and interval of the first adhesive layer 21 and the second adhesive layer 23 shown in FIG. 12B are also one example. Note that, FIG. 12A shows a state where the exciter 13 (a member to which the exciter 13 and the connection member 19 are fixed) is not fastened to the mounting member 17.

As described above, the following matters are disclosed in the present description.

(1) A glass diaphragm including:
a glass plate structure;
a mounting member that is fixed to the glass plate structure and to which an exciter for vibrating the glass plate structure is to be attached; and
an adhesive layer in contact with the glass plate structure and the mounting member, in which
the adhesive layer includes a first adhesive layer and a second adhesive layer made of different materials,
a material of the first adhesive layer is different from a material of the second adhesive layer,
the first adhesive layer has a shear storage modulus of 1.0×10⁷ [Pa] or less at −40 [° C.], and
the second adhesive layer has a shear peel strength of 0.2 [MPa] or more at 80 [C].

According to the glass diaphragm having this configuration, the glass plate structure and the mounting member to which a connection member to be fixed to the exciter is to be attached can be easily fixed to each other with a simple structure by the adhesive layer disposed between the glass plate structure and the mounting member.

In addition, the first adhesive layer and the second adhesive layer constituting the adhesive layer are made of different materials. The first adhesive layer has a shear storage modulus of 1.0×10⁷ [Pa] or less at −40 [° C.], and the second adhesive layer has a shear peel strength of 0.2 [MPa] or more at 80 [C]. Therefore, regardless of a temperature change, a large fixing strength between the glass plate structure and the mounting member can be maintained. Accordingly, even in extremely hot or cold regions, the exciter or a member in which the connection member and the exciter are integrated can be stably attached to the glass plate structure, and a decrease in quality of sound emitted from the glass diaphragm and falling off of the exciter due to displacement of the exciter can be prevented.

(2) The glass diaphragm according to (1), in which the first adhesive layer and the second adhesive layer are in contact with both the glass plate structure and the mounting member.

According to the glass diaphragm having this configuration, the mounting member can be satisfactorily fixed to the glass plate structure by the first adhesive layer and the second adhesive layer which are in contact with both the glass plate structure and the mounting member.

(3) The glass diaphragm according to (1) or (2), in which the first adhesive layer and the second adhesive layer have portions spaced apart from each other.

According to the glass diaphragm having this configuration, since the first adhesive layer and the second adhesive layer have portions spaced apart from each other, even when the first adhesive layer and the second adhesive layer thermally expand due to a temperature change, generation of a stress caused by the first adhesive layer and the second adhesive layer interfering with each other can be prevented.

(4) The glass diaphragm according to any one of (1) to (3), in which the mounting member has a step toward the glass plate structure.

According to the glass diaphragm having this configuration, when the mounting member has a step toward the glass plate structure, an area of the mounting member on a side fixed to the glass plate structure can be easily increased, and an adhesive strength of the mounting member to the glass plate structure by the first adhesive layer and the second adhesive layer can be increased.

(5) The glass diaphragm according to any one of (1) to (4), in which at least one of the first adhesive layer and the second adhesive layer has a loss coefficient tan δ of 0.01 or more at −40 [° C.].

According to the glass diaphragm having this configuration, since at least one of the first adhesive layer and the second adhesive layer has a loss coefficient tan δ of 0.01 or more at −40 [° C.], impact resistance in cold regions is improved, and a firmly fixed state of the mounting member to the glass plate structure can be maintained more satisfactorily.

(6) The glass diaphragm according to any one of (1) to (5), in which the adhesive layer has an average shear peel strength of 0.2 [MPa] or more in a range of −40 [C] to 80 [C].

According to the glass diaphragm having this configuration, since the adhesive layer has an average shear peel strength of 0.2 [MPa] or more in the range of −40 [C] to 80 [C], a fixing structure of the mounting member to the glass plate structure can be made more resistant to the temperature change.

(7) The glass diaphragm according to any one of (1) to (6), in which a thickness of the first adhesive layer and a thickness of the second adhesive layer are 1 [μm] to 1.0 [mm].

According to the glass diaphragm having this configuration, since the thickness of the first adhesive layer and the thickness of the second adhesive layer are 1 [μm] to 1.0 [mm], the vibration of the exciter can be efficiently transmitted to the glass plate structure via the mounting member while the adhesive strength of the mounting member to the glass plate structure is sufficiently ensured, and an acoustic effect is improved.

(8) The glass diaphragm according to (7), in which the thickness of the first adhesive layer is approximately the same as the thickness of the second adhesive layer.

According to the glass diaphragm having this configuration, since the thickness of the first adhesive layer is approximately the same as the thickness of the second adhesive layer, the mounting member can be adhesively fixed to the glass plate structure by the first adhesive layer and the second adhesive layer in a well-balanced manner.

(9) The glass diaphragm according to any one of (1) to (8), in which a ratio of a surface area S1 of the first adhesive layer to a surface area S2 of the second adhesive layer in a plan view of the glass plate structure is in a range of 1:0.01 to 1:100.

According to the glass diaphragm having this configuration, the surface areas of the first adhesive layer and the second adhesive layer in contact with the glass plate structure can be set to have an appropriate ratio, and the mounting member can be satisfactorily adhesively fixed to the glass plate structure by the first adhesive layer and the second adhesive layer.

(10) The glass diaphragm according to (9), in which a total area of the surface area S1 and the surface area S2 is 100 [mm²] or more.

According to the glass diaphragm having this configuration, the surface areas of the first adhesive layer and the second adhesive layer in contact with the glass plate structure can be sufficiently ensured, and the mounting member can be satisfactorily adhesively fixed to the glass plate structure by the first adhesive layer and the second adhesive layer.

(11) The glass diaphragm according to any one of (1) to (10), in which a center of gravity of the mounting member overlaps one of the first adhesive layer and the second adhesive layer in a plan view of the glass plate structure, and the one of the first adhesive layer and the second adhesive layer is disposed in a first region point-symmetric with respect to the center of gravity in the plan view of the glass plate structure.

According to the glass diaphragm having this configuration, since one of the first adhesive layer and the second adhesive layer overlaps the center of gravity of the mounting member and is disposed in the first region point-symmetric with respect to the center of gravity of the mounting member in the plan view of the glass plate structure, an adhesive force of one of the first adhesive layer and the second adhesive layer can be imparted between the glass plate structure and the mounting member in a well-balanced manner. Accordingly, the mounting member can be adhesively fixed to the glass plate structure in a well-balanced manner.

(12) The glass diaphragm according to (11), in which the other of the first adhesive layer and the second adhesive layer is disposed in a second region point-symmetric with respect to the center of gravity.

According to the glass diaphragm having this configuration, since the other of the first adhesive layer and the second adhesive layer is disposed in the second region point-symmetric with respect to the center of gravity of the mounting member in the plan view of the glass plate structure, an adhesive force of the other of the first adhesive layer and the second adhesive layer can be imparted between the glass plate structure and the mounting member in a well-balanced manner. Accordingly, the mounting member can be adhesively fixed to the glass plate structure in a more balanced manner.

(13) An exciter-attached glass diaphragm including: the glass diaphragm according to any one of (1) to (12); and an exciter.

According to the exciter-attached glass diaphragm having this configuration, the connection member is fixed to the mounting member fixed to the glass plate structure, and accordingly, the glass diaphragm can be made into an exciter-attached glass diaphragm including an exciter.

Note that, the present application is based on a Japanese Patent Application (No. 2022-082516) filed on May 19, 2022, contents of which are incorporated herein by reference.

### REFERENCE SIGNS LIST

11: glass diaphragm
13: exciter
15: glass plate structure
17: mounting member
19: connection member
20: adhesive layer
21: first adhesive layer
23: second adhesive layer
31a: step
100: exciter-attached glass diaphragm
G: center of gravity

What is claimed is:

1. A glass diaphragm comprising:
a glass plate structure;
a mounting member that is fixed to the glass plate structure and to which an exciter for vibrating the glass plate structure is to be attached; and
an adhesive layer in contact with the glass plate structure and the mounting member, wherein
the adhesive layer comprises a first adhesive layer and a second adhesive layer,
a material of the first adhesive layer is different from a material of the second adhesive layer,
the first adhesive layer has a shear storage modulus of 1.0×10⁷ [Pa] or less at −40 [° C.], and
the second adhesive layer has a shear peel strength of 0.2 [MPa] or more at 80 [C].

2. The glass diaphragm according to claim 1, wherein the first adhesive layer and the second adhesive layer are in contact with both the glass plate structure and the mounting member.

3. The glass diaphragm according to claim 1, wherein the first adhesive layer and the second adhesive layer comprise portions spaced apart from each other.

4. The glass diaphragm according to claim 1, wherein the mounting member comprises a step toward the glass plate structure.

5. The glass diaphragm according to claim 1, wherein at least one of the first adhesive layer and the second adhesive layer has a loss coefficient tan δ of 0.01 or more at −40 [C].

6. The glass diaphragm according to claim 1, wherein the adhesive layer has an average shear peel strength of 0.2 [MPa] or more in a range of −40 [C] to 80 [C].

7. The glass diaphragm according to claim 1, wherein a thickness of the first adhesive layer and a thickness of the second adhesive layer are 1 [μm] to 1.0 [mm].

8. The glass diaphragm according to claim 7, wherein the thickness of the first adhesive layer is approximately the same as the thickness of the second adhesive layer.

9. The glass diaphragm according to claim 1, wherein a ratio of a surface area S1 of the first adhesive layer to a surface area S2 of the second adhesive layer in a plan view of the glass plate structure is in a range of 1:0.01 to 1:100.

10. The glass diaphragm according to claim 9, wherein a total area of the surface area S1 and the surface area S2 is 100 [mm²] or more.

11. The glass diaphragm according to claim 1, wherein a center of gravity of the mounting member overlaps one of the first adhesive layer and the second adhesive layer in a plan view of the glass plate structure, and
the one of the first adhesive layer and the second adhesive layer is disposed in a first region point-symmetric with respect to the center of gravity in the plan view of the glass plate structure.

12. The glass diaphragm according to claim 11, wherein the other of the first adhesive layer and the second adhesive layer is disposed in a second region point-symmetric with respect to the center of gravity.

13. An exciter-attached glass diaphragm comprising:
the glass diaphragm according to any claim 1; and
an exciter.
